(19) United States
(12) Patent Application Publication
(10) Pub. No.: US 2007/0289996 A1
(43) Pub. Date: Dec. 20, 2007

(54) Polyurethane and epoxy adhesive applicator systems

(76) Inventors: Todd Alan Wheatcraft, Prior Lake, MN (US); Timothy James Leonard, Delano, MN (US); Tony Lee Leonard, Maple Grove, MN (US); James David Leonard, Chaska, MN (US)

Correspondence Address: CHRISTOPHER D. HARRINGTON, SUITE 350, 5300 CORPORATE GROVE DRIVE SE, GRAND RAPIDS, MI, 49512, US

(21) Appl. No.: 11/455,473

(22) Filed: Jun. 19, 2006

(51) Int. Cl. B67D 5/52; B67D 5/60

(52) U.S. Cl. 222/137; 222/145.6

(57) ABSTRACT

A novel applicator for use in applying polyurethane and epoxy adhesives or cement to roofing components is disclosed where the applicator comprises a paired set of cartridges that are held together in spaced relation by at least one face plate, and where the cartridges include retainers for retaining a cap installed on the plunger end of each of the cartridges. The cap further comprises a plunger well for the receipt of the end of a plunger member of a dispenser and where the cap is displaceable within the inner bore of each of such cartridge under the urging of the dispenser resulting in the extrusion of a component of a two-part adhesive or cement into a mixing tube for mixing and dispensing through the tip of the mixing tube. The present invention preferentially includes two face plates for the display of product related information, one on each of the front and rear of the cartridge assembly.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to adhesive and cement applicators. More specifically, the present invention relates to polyurethane and epoxy adhesive applicators and the cartridges for same.

Polyurethane adhesives are well known and have many functional advantages over other types of bonding agents not the least of which is their strength and shelf life as compare to some other types of chemistries. The polyurethane and epoxy adhesives and cements relating to the present invention are typified by the use of two reactive components that are brought together, mixed, and then applied in quick succession. The components are a polymeric resin and a “hardener” which will cause a chemical reaction when combined, the rate and completeness of the reaction being controlled by the ratio of the volume of the hardener to the resin, resulting in a very tight bond between any surfaces that are made fast with the glue. Polyurethane and epoxy adhesives and cements are noted for their great resistance to weather and for their durability and for these reasons they are selected for many commercial and industrial applications.

One application in particular is the usage of polyurethane roof cements for roofing installations and repairs. Modern roof systems employ plastic membranes that are spread across great expanses of roof area. The membranes come in rolls that when laid out have to be sealed along their edges one to another. In addition, there are other areas where penetrations occur within the roof field that need to have custom pieces of membrane applied or that need to be adhered to flashings or the like. In other applications of the present invention, the adhesive is used to install insulation boards on roofing systems. The adhesive is used to adhere the insulation boards to the roof deck, or a pre-existing membrane or other structure. In all of these situations the usage of polyurethane adhesive is preferred because of its durability and resistance to weather. Epoxy adhesives or cements may also be used although polyurethane is more commonly selected for these types of applications.

The actual distribution of the polyurethane chemistry has been a long standing problem in the industry. Ensuring that the proper quantities of resin and hardener are ejected and mixed is critical to the effectiveness of the application. In addition, the need exists for simple systems that can manage this function in the field such that roofing installers can readily handle and apply the adhesive without resort to exotic methods or equipment. As a result, there have been approaches developed in the prior art that solve some of these problems, for instance the dispensing system taught in U.S. Pat. No. 5,082,147 (Jacobs) which uses a dual barrel cartridge system that is insertable into a gun-type dispenser. The cartridges each contain one of the adhesive ingredients which are held segregated until they are needed for use. Reference is made to FIG. 1, where an example of a prior art dispensing system is shown similar to the one disclosed in U.S. Pat. No. 5,082,147. In that system, the cartridge applicator 10 is retained in the dispenser 22. The applicator includes the cartridge barrels 12 which each have a plunger end 14 and each are joined at the delivery port 16. Projecting from the delivery port 16 is the mixing tube 18 with tip 20.

The cartridge applicator 10, as mentioned above, resides in the dispenser 22 and is used by means of plungers 24 (not fully shown) which force the resin and hardener out of each individual cartridge, through the delivery port and into the mixing tube where they are mixed. Mixing commences the chemical reaction which occurs and goes to completion as the epoxy mix is applied through the tip and onto the surface of the roofing material as desired. The prior art cartridges may be offered individually or they may be linked together as one unit. Typically the end of the cartridge that forms up or is engaged with the delivery port 16 is capped to prevent leakage and/or cross mixing of the adhesive chemistry.

The mixing tube 18 is typically mounted onto the deliver port 16 just prior to use. All of the components, except for the dispenser, are typically fabricated from plastic with the intention of a single use. This allows the installers to spend their time on the application of the cement where needed and not to worry about filling any of the cartridges or having to clean up tools. Once spent, the cartridges are merely thrown away.

Still with all of the improvements and advancements in the field of adhesive application systems, problems persist that hamper the use of the dual cartridge approach and which impede the speed and ability of the installer to do their tasks. One of these is the situation where the cartridges are supplied separately requiring the installers to join them when preparing them for insertion into the dispenser. This means that the cartridges must be aligned correctly and typically connected to each other before being placed into the dispenser. One example of this may be found in U.S. Pat. No. 5,249,709 (Duckworth, et al) where individual cartridges are brought together and can be “snap-fit” to each other prior to insertion. Other systems are known where the paired cartridges are affixed to each other along their tangents and at the area of the delivery port. These paired units are insertable into the dispenser however the affixation of one to the other is less than robust and can at times lead to the unintentional separation of the cartridges. If this occurs, damage may result that would require that the particular cartridges be thrown away without being used.

The joining of the two cartridges is not an insignificant matter since the two meet at the delivery port for common ejection of their contents into the mixing tube. This area is rather fragile as compared to the rest of the applicator system and any tension placed on the delivery port by way of the separation of the individual cartridges can lead to cracking of the delivery port or the cartridge.

Another problem that arises during the use of the applicators is the occasional loss of the cap(s) at the plunger end of the cartridges. In the usual case, the caps are used as part of the plunger system and the tip of the plunger member of the dispenser is inserted into the cap and the cap is urged towards the delivery port, thereby causing the resin and the hardener to be dispensed. Since the delivery end of the cartridges is sealed prior to use, any expansion of the chemistry or the evolution of any gases will usually cause the cap to move. In some of the prior art device, the cap and cartridge are supplied with a vent for purging any gases. In other situations the volume of the resin and hardener in the tube may be adjusted to allow for some contraction and expansion, however without resort to any these approaches the typical cartridge that is capped runs the risk of having the cap being ejected from the end of the cartridge, thereby resulting in resin or hardener possible being leaked over tools, equipment or other items, not to mention the loss of the chemistry for use in the installation.

Another deficit that has been observed in the field, is the fact that the cartridges in the usual application do not have any suitable surface that allows for any messages. The directions for use as well as safety precautions are a necessary reference for those who use adhesives and cements and if the installer is located on the top of a building at the time the need arises for a consultation with any product related information, it is a huge disadvantage to have to leave the job in order to find the needed information. In addition, branding of the cartridge system so that the installer knows which company makes the particular product is highly relevant and useful information that helps to maintain consistency when working a particular job or when working with the same membrane or insulation boards on successive jobs. Thus a surface on the cartridge that provides a space for imparting such information would be an important adjunct to the use of the epoxy applicator.

The attributes and benefits of the present invention will be discussed in more detail herein.

### SUMMARY OF THE INVENTION

A new applicator for use in a dispenser for roofing applications comprises a dual barrel cartridge assembly with a joint delivery port with a mount therein for coupling with a mixing tube. The applicator of the present invention includes a cap that has at least a pair of cap locks disposed about its circumference, and where the cap locks engage the cartridge and prevent the cap from being ejected from the end of the cartridge. In addition, the applicator has at least one face plate for binding the paired cartridge barrels together and which also provides a surface for the inclusion of product-related information.

In the preferred embodiment, the dual cartridge applicator of the present invention is assembled from individual components some of which are solvent welded or welded through ultra-sonic means where required. The resultant product is stronger than heretofore has been known in the prior art as far as applicators that have been assembled from components.

### BRIEF DESCRIPTION OF THE DRAWINGS

FIG. 1 is an isometric view of a prior art applicator as installed in a dispenser.

FIG. 2 is an isometric view of an applicator of the present invention as installed in a conventional dispenser.

FIG. 3 is a side view of the cartridges of the present invention with the face plates attached.

FIG. 4 is a top view of the cartridges of the present invention with the face plates attached.

FIG. 5 is an isometric view of the cap of the present invention.

FIG. 6 is a front elevational view of the cartridges of the present invention, without the face plates installed.

FIG. 7 is a front elevational view of the cartridges as shown in FIG. 6, with the face plates installed.

FIG. 8 is a top view of the cap of the present invention.

FIG. 9 is a side cross sectional view of the cap plug of the present invention.

FIG. 10 is an isometric view of the nozzle cap of the present invention.

FIG. 11 is a side cross sectional view of the nozzle cap of FIG. 10.

FIG. 12 is an isometric view of the mixing tube for use with the present invention.

### DETAILED DESCRIPTION OF THE PREFERRED EMBODIMENTS

A new adhesive or cement applicator for use in roofing applications and the like, is disclosed in the drawings and within this specification. The present invention is primarily directed towards roofing applications, however, it may easily be used in any situation where two-part chemistry needs to be dispensed under conditions that require efficiency, control and safety.

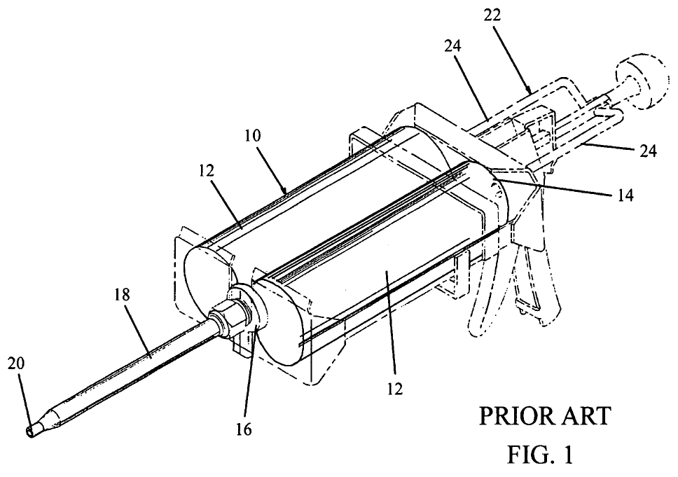

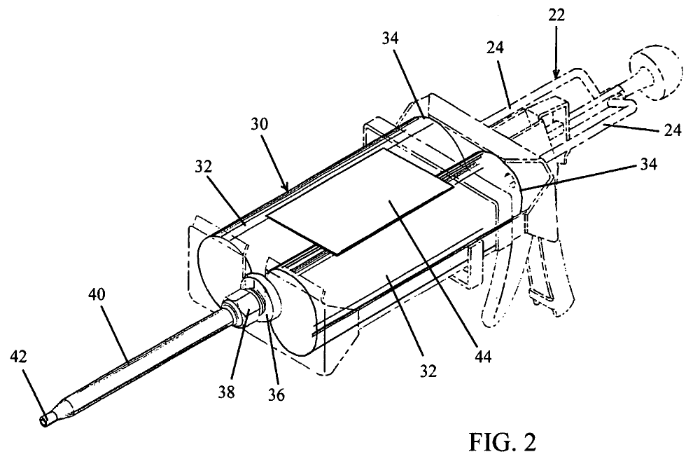

Turning now to FIG. 2, an applicator 30 of the present invention is shown with cartridge(s) 32. Each cartridge 32 includes a plunger end 34, and an end connected to a delivery port 36. The delivery port 36 is attached to the mixing tube 40 by means of the coupler 38. The mixing tube 40 includes the tip 42. Connecting each of the two cartridges 32 is the face plate 44. As was the case in FIG. 1, the dispenser 22 is shown in phantom with the plunger member 24 partially shown. Reference is made to the prior art with respect to the structure of the dispenser which is typically common to many of the cartridge systems, otherwise the present invention relates to a cartridge system that can be used in an applicator and the dispenser to be used is a matter of selection for one skilled in the art.

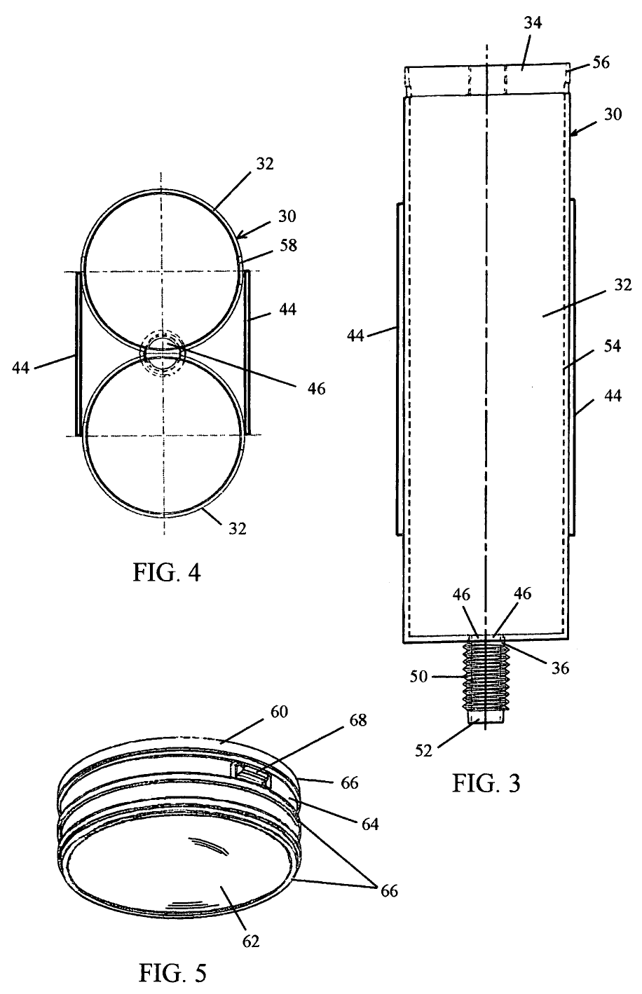

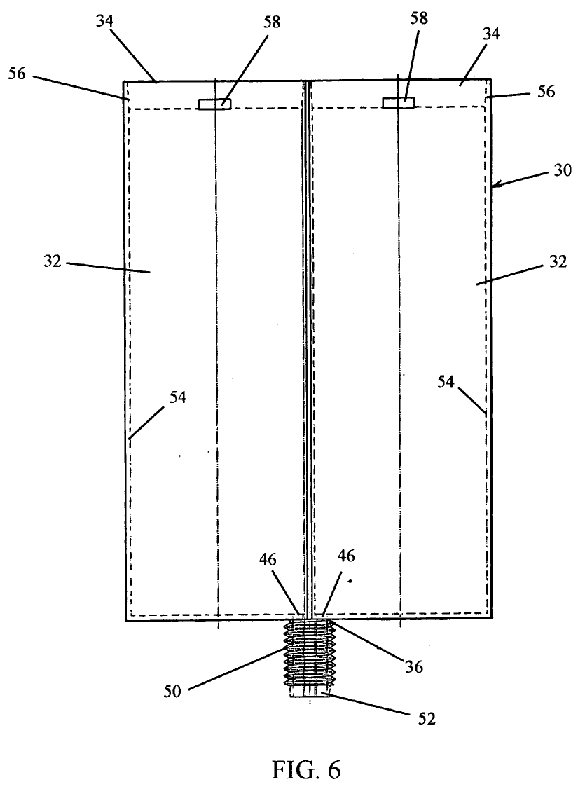

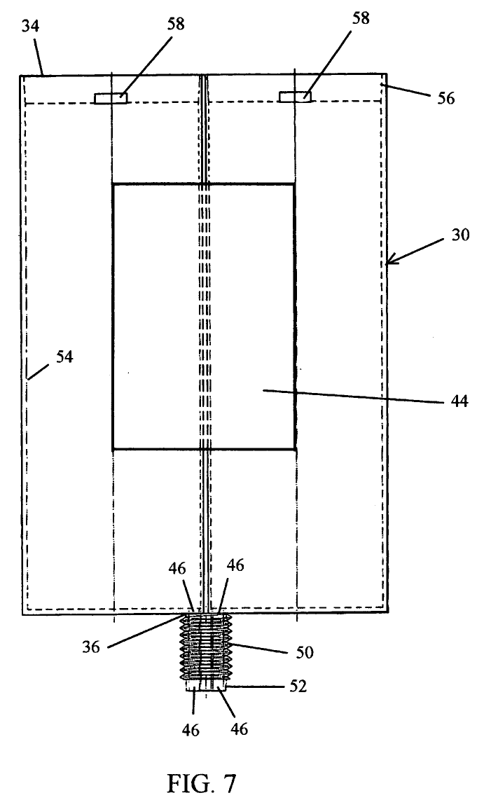

A portion of the applicator 30 of the present invention is shown in FIG. 3, with the through holes 46 at the delivery port 36 end of the cartridge 32, and where the delivery port 36 further includes the threads 50, and the port end 52. Also, as can be seen in phantom inside the cartridge 32, the inner bore 54, the lead-in taper 56 and the cap lock retainer 58. The face plate 44 can be seen as mounted on both the front and the rear of the cartridges 32. In FIGS. 4, 6 and 7, the same features are generally visible excepting that the face plate 44 is omitted from FIG. 6 to allow a view of the cartridges 32.

In FIG. 5, the cap 60 is shown with the cap bottom 62, the cap sides 64, the sealing rings 66 and the cap lock 68. In FIG. 8, the cap 60 is shown from the top and includes the cap top 70, the web portion 72, the plunger well 74 and the plunger centering hole 76. In close association, the cap plug 80 is shown in FIG. 9 with the cap plug top 82 and the cap plug projection 84.

FIGS. 10 and 11 reveal the nozzle cap 90 which fits onto the port end 52 and engages the port threads 50 when the epoxy cement applicator 30 is received by the installer. The nozzle cap 90 includes the nozzle cap flanges 92, the nozzle cap end 94, the nozzle cap threads 96 and the nozzle cap plug 98. When installed on the port end 52, the nozzle cap 90 seals the delivery port 36 and prevents any leakage of the components of the adhesive system and from cross contamination.

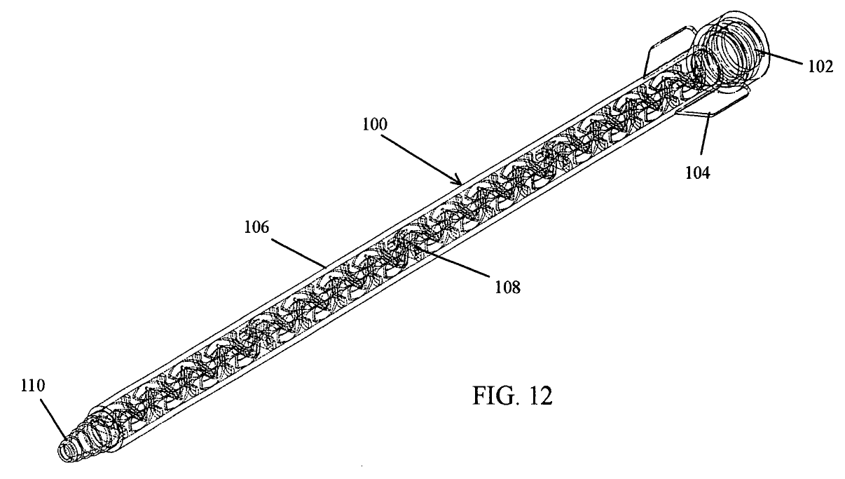

FIG. 12 discloses one type of mixing tube 100 that may be used with the present invention, and the mixing tube includes the mixing tube coupler 102, the mixing tube flanges 104, the mixing tube body 106, the mixing tube tip 110, and shown in phantom are the mixing tube corkscrews 108 which are internal to the mixing tube 100.

With the foregoing in mind, the applicator 30 of the present invention is typically provided with cartridges 32 that are filled with the appropriate resin and hardener. The size of the cartridges 32 shown in the drawings are equal which is appropriate for resin and hardener systems that require a 1:1 ratio for mixing, although it is known in the prior art that the cartridges 32 can be sized to match a required ratio of chemistry. The cap(s) 60 are installed on top of each of the cartridges 32 by insertion into the cartridge inner bore 54 in an orientation where the cap locks 68 are aligned with the cap lock retainer(s) 58. The cap lock retainer 58 is a recess formed in the top of the inner bore 54 of a cartridge 32 corresponding to the cap lock 68. Upon a sufficiently deep insertion, each cap lock 68 will engage the corresponding cap lock retainer 58 which will prevent the release of the cap 60. The cap lock 68 comprises a flexible tab that is resilient enough to be folded back when enough pressure is applied yet it provides some holding bias when it engages the corresponding cap lock retainer 58. Under conditions where other caps known in the prior art would move within the inner bore 54 depending on the expansion and/or contraction of the components being held in the cartridges 32, the cap(s) 60 of the present invention will be retained in place. Also, it is noted that the cap bottom 62 reflects a concave profile in the preferred embodiment which assists in the resistance of the cap 60 to any pressures being applied to it.

The applicator 10 is offered with the cartridges 32, caps 60 and the delivery port 16 pre-assembled. The delivery port is sealed with the nozzle cap 90 as described above, although additional types of sealing devices may be used and are known in the prior art, such as so-called “nose plugs” which are a joined pair of projections that fit the inner profile of the through holes 46. The nose plug is insertable into the through holes 46 and provides another measure of security as far as preventing cross contamination or leakage. The nose plug may be used in conjunction with the nozzle cap 90 of the present invention as may be desired. Of particular importance in the present invention is the use of the face plate 44 to affix the cartridges 32 together. The face plate 44 is attached to the exterior of each of the cartridges 32, in a fashion that is somewhat tangential in that the face plate 44 sides contact a small portion of the exterior radius of each such cartridge 32. Attachment is by means of solvent weld or sonic weld. Unlike the prior art device which are assembled using a bracket like interface between the cartridge circumference, or in one case, a snap-fit engagement that has the cartridges assembled just prior to use, the present invention relies on the face plate 44 to firmly orient and retain the cartridges 32 together as one unit. In the preferred embodiment the face plate 44 is installed on both the front and rear of the cartridges 32 as shown in the drawings, or in the alternative, a face plate 44 may be installed on one side of the paired cartridges only. The face plate 44 is preferentially composed of the same plastic material as the rest of the assembly and would be subject to solvent or sonic welding. Once the cartridges 32 are assembled in this fashion there is no possibility that they will disengage thereby destroying the delivery port 16 or other components of the device.

In addition to the structural integrity that the face plate 44 brings to the applicator 30, it turns out that it provides a convenient place for the presentment of branding and product information. This is very important for a number of reasons since the adhesive is comprised of a resin and hardener which are chemicals that possess a number of application considerations. For example, the conditions for installation are specific and this information needs to be readily available to the installer. The temperature of use, the duration of contact needed, the compatibility with differing types of roof membranes or board types are just some of the items of pertinent information that need to be imparted to the user. In the prior art the cartridges do not easily admit to placement of this information given the radiussed feature of the cartridges. In addition, the branding of the applicator is something that would be appreciated by the installer since preferences do develop with respect to the use of a particular adhesive for a given type of roof membrane or insulation board or a given type of roof project. The readily displayable brand and style of product ensures that the right selection will be made from the supplies of roof cement that might be available to an installer. Lastly, safety and instructional information can be easily displayed on the present invention. While many installers will not necessarily need instruction on the actual methods of using the product, the do-it-yourself type installer will need the information and having it on board the applicator will be a bonus rather than having to halt a project mid-stream in order to find the packaging associated with the product in order to determine the proper use. The safety issue is also something that is germane to both the installer and the do-it-yourself person since some people do exhibit a very rare but nonetheless a very potent reaction to certain adhesive chemistries and it is very important that this information be readily available and displayable so any affected user will now how to respond if it were to affect him/her.

Once the applicator 30 is loaded into the dispenser 22, the installer will typically remove the nozzle cap 90 and then install the mixing tube 100 onto the delivery port end 52. This can be done by hand and is usually a matter of screwing the threaded components together although a bayonet type of attachment system is known for coupling these components together as well. The plunger members 24 are aligned to contact the cap top 70, and in particular the ends (not shown) of the plunger members 24 are typically designed to mate with the plunger well 74 and with the plunger center 76 in the cap 60. In the preferred embodiment the cap 60 is forced down the inner bore 54 of the cartridge 32 (done in pairs) which extrudes the resin or the hardener out the through holes 46 and out the delivery port 16 and into the mixing tube 100. The two chemistries meet and are mixed within the body 106 of the mixing tube 100 and this process is encouraged by means of the corkscrews 108 which purposefully disrupt and mix the chemistry streams as they flow through. The end result is thoroughly mixed adhesive or cement that exits the tip 110 of the mixing tube 100 in the appropriate chemical ratio. The adhesive or cement is applied to the roofing component that is to be cemented and this process continues until all the gluing is completed or until the cartridges 32 are empty of resin and hardener. In either event, the applicator 30 is then removed from the dispenser 22 in the reverse manner and the carcass is disposed of as normal. In the event more gluing is needed, the process is repeated.

The construction of the present invention may result from a number of plastic resins such as polypropylene, nylon and polyester. Typically the components are formed using plastic injection molding techniques although as described above, parts will still need to be assembled to form the completed version of the invention. Other methods and materials may be used to achieve the benefits of the teachings herein, although it is asserted that variations on the concepts presented are included within the spirit and scope of the present invention. Nothing within this specification is intended to limit or restrict the teachings of the invention in any way.

I claim:

1. An applicator for use in a two-part adhesive dispenser, for the retention of and controlled dispensation of a resin and a hardener, the applicator comprising;
Paired cartridges joined together in a spaced configuration, each cartridge having a plunger end and a deliver end and with an inner bore, and where each cartridge includes at least one locking recess on the inner bore and substantially near the plunger end;
A cap associated with each cartridge for fitting in the inner bore of said cartridge and preventing the leakage of the contents of the cartridge and where said cap includes at least one tab for reversibly locking with the locking recess, said cap including a plunger well for the receipt of a plunger end;
A delivery port at the delivery end of the cartridges through which delivery port the contents of each of said cartridge can be extruded;
A mixing tube fittable onto the deliver port for connection of the mixing tube to the delivery port allowing the flow of the extruded contents of the cartridges to be mixed; and,
A tip at the end of said mixing tube for the ejection of the mixed contents of the cartridges for application onto an area to receive epoxy roof cement.

2. The applicator of claim Number 1, where the cap includes at least a pair of cap locks and each cartridge includes at least a pair of locking recesses.

3. The applicator of claim Number 1, where the applicator further includes;
At least one face plate affixed to the exterior of each cartridge in proximate tangential fashion, the face plate thereby retaining each cartridge relative to the other in a fixed orientation, and where each face plate is compatible with the display of product related information.

4. The applicator of claim Number 3, where the applicator includes a pair of face plates, one mounted on the front of the paired cartridges and with one mounted on the rear of the paired cartridges.

5. The applicator of claim Number 1, where the cartridges, the caps, the deliver port and the mixing tube are fabricated from a plastic resin.

6. An applicator for use in a two-part adhesive dispenser, for the retention of and controlled dispensation of a resin and a hardener, the applicator comprising;
Paired cartridges joined together in a spaced configuration, each cartridge having a plunger end and a deliver end and with an inner bore, and where each cartridge includes at least one locking recess on the inner bore and substantially near the plunger end;
A cap associated with each cartridge for fitting in the inner bore of said cartridge and preventing the leakage of the contents of the cartridge and where said cap includes at least one tab for reversibly locking with the locking recess, said cap including a plunger well for the receipt of a plunger end;
At least one face plate affixed to the exterior of each cartridge in proximate tangential fashion, the face plate thereby retaining each cartridge relative to the other in a fixed orientation, and where each face plate is compatible with the display of product related information;
A delivery port at the delivery end of the cartridges through which delivery port the contents of each of said cartridge can be extruded;
A mixing tube fittable onto the deliver port for connection of the mixing tube to the delivery port allowing the flow of the extruded contents of the cartridges to be mixed; and,
A tip at the end of said mixing tube for the ejection of the mixed contents of the cartridges for application onto an area to receive adhesive.

7. The applicator of claim Number 6, where the applicator includes a pair of face plates, one mounted on the front of the paired cartridges and with one mounted on the rear of the paired cartridges.

8. The applicator of claim Number 6, where the cap includes at least a pair of cap locks and each cartridge includes at least a pair of locking recesses.

9. The applicator of claim Number 6, where the cartridges, the caps, the face plates, the deliver port and the mixing tube are fabricated from a plastic resin.

10. An applicator for use in a two-part adhesive dispenser, for the retention of and controlled dispensation of a resin and a hardener, the applicator comprising;
Paired cartridges joined together in a spaced configuration, each cartridge having a plunger end and a deliver end and with an inner bore;
A cap associated with each cartridge for fitting in the inner bore of said cartridge and preventing the leakage of the contents of the cartridge, said cap including a plunger well for the receipt of a plunger end;
At least one face plate affixed to the exterior of each cartridge in proximate tangential fashion, the face plate thereby retaining each cartridge relative to the other in a fixed orientation, and where each face plate is compatible with the display of product related information;
A delivery port at the delivery end of the cartridges through which delivery port the contents of each of said cartridge can be extruded;
A mixing tube fittable onto the deliver port for connection of the mixing tube to the delivery port allowing the flow of the extruded contents of the cartridges to be mixed; and,
A tip at the end of said mixing tube for the ejection of the mixed contents of the cartridges for application onto an area to receive adhesive.

11. The applicator of claim Number 10, where the applicator includes a pair of face plates, one mounted on the front of the paired cartridges and with one mounted on the rear of the paired cartridges.

12. The applicator of claim Number 10, where each cartridge includes at least one locking recess on the inner bore and substantially near the plunger end, and where cap includes at least one tab for reversibly locking with the locking recess

13. The applicator of claim Number 12, where the cap includes at least a pair of cap locks and each cartridge includes at least a pair of locking recesses.

14. The applicator of claim Number 10, where the cartridges, the caps, the face plates, the deliver port and the mixing tube are fabricated from a plastic resin.
